(19) United States
(12) Patent Application Publication
(10) Pub. No.: US 2017/0284723 A1
(43) Pub. Date: Oct. 5, 2017

(54) REFRIGERATION FOR GROCERY DELIVERY TOTES

(71) Applicant: Michael D. Newman, Hillsborough, NJ (US)

(72) Inventor: Michael D. Newman, Hillsborough, NJ (US)

(21) Appl. No.: 15/471,011

(22) Filed: Mar. 28, 2017

Related U.S. Application Data
(60) Provisional application No. 62/317,681, filed on Apr. 4, 2016.
(60) Provisional application No. 62/363,367, filed on Jul. 18, 2016.

(51) Int. Cl. F25D 3/12; A23L 3/36

(52) U.S. Cl. CPC F25D 3/125; A23L 3/364; A23V 2002/00; F25D 2303/0831

(57) ABSTRACT

A method for calculating a dry ice block necessary to preserve a product during transport, includes calculating a surface area:weight ratio needed for the dry ice block to preserve the product in at least one of a chilled condition and a frozen condition, and forming the dry ice block into a shape having said surface area:weight ratio. A related apparatus is also provided.

### BACKGROUND OF THE INVENTION

The present embodiments relate to apparatus and methods to provide cryogenic chilling for products to be transported and in particular to food products that require chilling and/or freezing during the transportation to an end user.

The grocery delivery business, such as for example for home delivery, has many challenges. One of the greatest challenges is being able to control temperature of the products during the transportation process.

This is especially critical when food products are being transported for home delivery to consumers of the food products.

It has been known to use carbon dioxide (CO₂) snow, dry ice pellets, or blocks of ice positioned with groceries in the tote during the transportation process. Frequently, the distributor will simply place the snow, pellets or ice blocks with the product or inside the transport tote to surround the product. This arrangement of the chilling substance in known methods presents many challenges. Such challenges include the direct contact of the dry ice with the food product which can damage same sufficient enough to make it inedible. There is also no control over the internal temperature of the transport tote and therefore, the known methods can only be reused with frozen products because the sensitivity of known methods does not sufficiently enable chilled products to be transported. There is additionally no control over sublimation rates of the snow, pellets and ice blocks and therefore, the refrigeration cannot be controlled which is especially detrimental if the food product must be transported to an extreme remote location and environmental conditions will vary during the journey. In effect, known ice blocks are not constructed, formed or tailored for the particular transport application. Finally, there is a safety risk to consumers who may accidently touch residue dry ice and be subjected to harmful ice burn.

### SUMMARY OF THE INVENTION

There is therefore provided herein a method embodiment for calculating a dry ice block necessary to preserve a product during transport, which includes calculating a surface area:weight ratio needed for the dry ice block to preserve the product in at least one of a chilled condition and a frozen condition; and forming the dry ice block into a shape having said surface area:weight ratio.

The method may also include positioning the dry ice block having the shape with the product for transport.

The method may further include restraining movement of the dry ice block during the transport.

Another embodiment provided herein is an apparatus for transporting a product in at least one of a chilled condition and a frozen condition, which includes a dry ice block with a surface area:weight ratio for providing at least one of said chilled and frozen conditions for the product; a container having a chamber therein sized and shaped to receive the dry ice block; and a tote having an internal space therein sized and shaped to receive the product and the container.

The apparatus may also include the container having sidewalls constructed and arranged to immobolize the dry ice block in the chamber during transport.

Another embodiment includes an apparatus for extruding a dry ice block to be transported with a perishable product, which includes a cylinder having a chamber therein and in which a piston is disposed for reciprocal movement, and an outlet for the chamber; a pipe in communication with the chamber for introducing CO₂ snow into the chamber; a die having a select cross-section shape for the dry ice block, the die removably mountable to the outlet to be interchangeable with another die having another cross-section shape; and a cutting member positioned downstream of the outlet for cutting an individual ice block from said outlet, said individual ice block having a surface area:weight ratio for providing at least one of a chilled condition and a frozen condition to the perishable product.

The present embodiments provide other elements and features as described below.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a side view of an apparatus for providing blocks of dry ice, which ice blocks result from a method of the present embodiments;

FIGS. 2A-2C show cross-section views of dry ice or CO₂ blocks from the apparatus of FIG. 1;

FIGS. 3A-3C show side cross-section, top perspective and side cross-section views, respectively, of containers for use with the CO₂ ice blocks and a delivery tote;

FIG. 4 shows a side view in cross-section of the container being mounted within a delivery tote in which food product is also transported; and

FIG. 5 shows a top perspective view of a dry ice block which can be used in the container of the apparatus.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

Referring generally to the Figures, a first stage of a method embodiment of the present invention includes formation of dry ice blocks.

For stage one, the rate of sublimation of dry ice (CO₂) is proportional to a surface area of that dry ice. With known transit conditions and requirements for product holding temperatures during delivery, the dry ice blocks can be formed with physical characteristics to match refrigeration requirements and sublimation rates. Therefore, the dry ice block surface area to weight or surface area to mass ratio (surface area:weight; surface area:mass) is adjusted to match required sublimation rates which contribute directly to a refrigeration requirement. That is, if only a chilled environment is required, a dry ice block with a lower surface area to weight ratio will be formed; while a higher surface area to weight ratio will be used for the dry ice block for a frozen product. A mass of the dry ice block is adjusted based upon time required in chilled or frozen state, as well as external conditions, product properties and tote insulation. With an extruding machine as discussed below, blocks can be automatically mass produced and surface area to weight customized for requirements of each tote and the products being transported therein.

A second stage of the method embodiment includes placement and storage of dry ice blocks in a specialized refrigeration container which is positioned in a grocery delivery container or tote.

For the second stage, the purpose of the container is to contain the formed dry ice block and prevent movement of or immobilize same by pressure fit, for example, in the container during transport. This fit will substantially reduce if not eliminate breakage or fracturing of the block. If the ice block is broken, such will effect the block's surface area and related sublimation. Additionally, storage of the dry ice block in the container will conceal the block and prevent contact with same by the end use consumer.

The container may be further constructed with one side thereof having a higher R-factor insulating material. A higher R-factor material can be used to supplement control of sublimation of the dry ice block. For example, if a further reduction in sublimation is required of the block, a high R-factor material could be used to insulate one side of the container such that when the container is placed in a tote, less heat is removed from the product area of the tote. The container can be made with a thin plastic bottom and an aerogel insulated top, for example. This configuration will reduce the overall size of the container and therefore allow more room in the tote for food products or groceries.

The tote can also be constructed of insulated panels with a high R-factor. Plastic VIP (vacuum insulated panels) or aerogel filled panels can be used to minimize ingress of heat to an interior of the container from the environment external to the tote.

FIGS. 1-5 show with more particularity the elements and embodiments of refrigeration, and including method embodiments of refrigeration for grocery delivery totes.

Referring to FIG. 1, an apparatus is shown generally at 10 for forming the dry ice block 12 or a plurality of the blocks used in the present embodiments. The apparatus 10 includes an extruder apparatus 14 with a cylinder 15 having a chamber 16 therein and in which a piston 18 is movable. CO₂ snow 20 is introduced into the chamber 16 through a pipe 22 or inlet in communication with the chamber. A die 24 having a particular cross-section shape (to impart a shape to the dry ice block 12 is mounted to one end of the chamber 16 and through which compressed CO₂ snow is forced by the piston 18 to provide the dry ice block 12. A region of the extruder 14 is provided with a slot 26 in which dies of different cross-section shapes can be removably mounted at the chamber 16 upstream of an outlet 28 of the chamber. With this manner of construction of the apparatus 10, different dies may be selectively used so that dry ice blocks 12 of different shapes are extruded from the apparatus through the outlet 28. A cutting member 30 such as a blade for example is disposed external to the extruder 14 and downstream of the outlet 28 to cut or slice-off individual dry ice blocks 12 from the extruded block, which are then transported away on a conveyor 32.

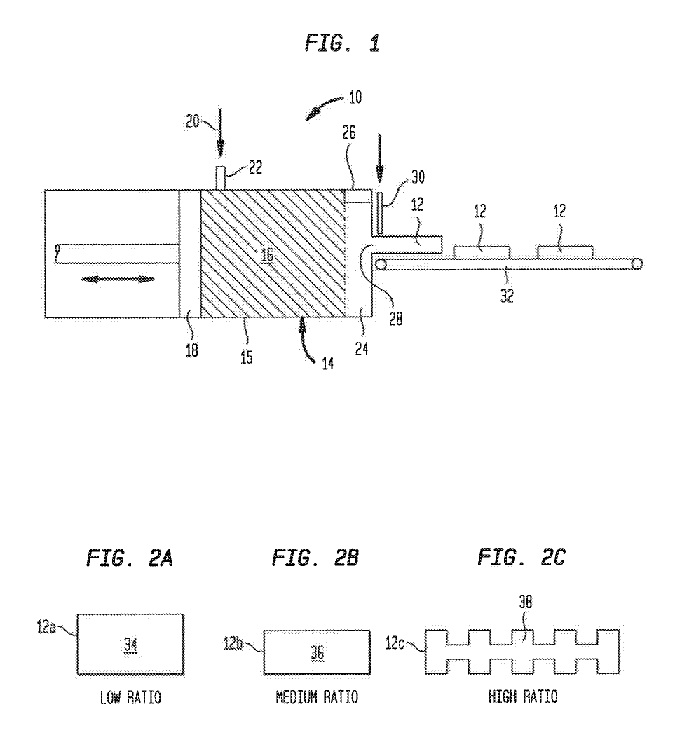

As shown in FIGS. 2A-2C, the die 24 selected can have a particular cross-section shape to result in a particular dry ice block 12a having its own specific surface area:mass ratio. For example, a cross-section shape 34 of the dry ice block 12a is shown in FIG. 2A would possess a low ratio i.e., its surface area:mass ratio would provide for low sublimation which would translate into a low rate of refrigeration. The dry ice block 12b having a cross-section shape 36 as shown in FIG. 2B would have, relatively speaking, a medium ratio, i.e. a medium sublimation which translates into a medium rate of refrigeration. The dry ice block 12c having the shape 38 in FIG. 2C would have a high ratio of the surface area:mass ratio, which would provide a high sublimation rate and therefore translate into higher refrigeration or higher heat flux of products to be chilled or frozen.

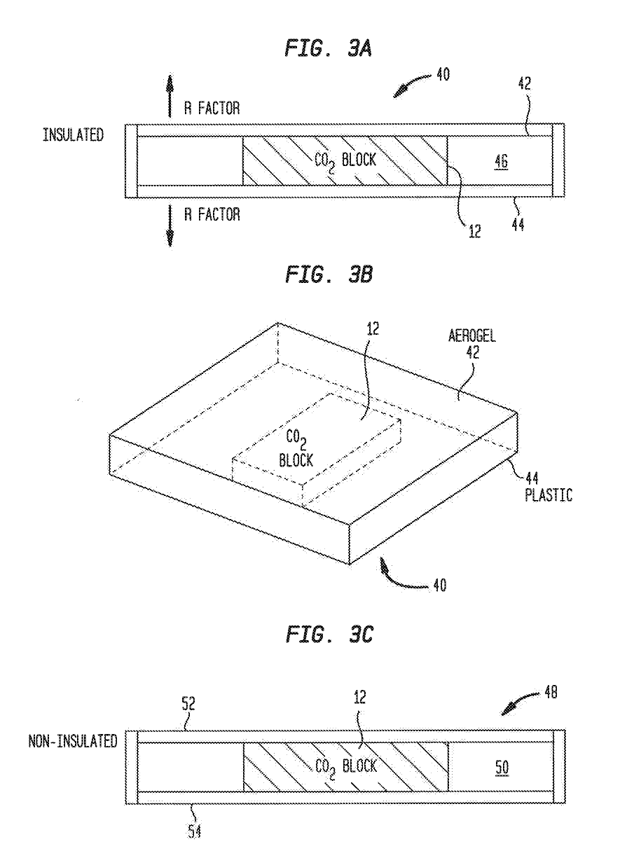

After the dry ice block 12 is selected and produced for the particular transport operation, such dry ice block is deposited in a container 40 to be retained therein during the transport of the perishable items, such as for example food products or groceries. Referring to FIGS. 3A and 3B, an insulated container 40 is shown with the dry ice block 12 disposed therein. The container 40 can include an openable top 42 which can consist of aerogel for providing a particular R-factor (heat flux factor). A bottom 44 can be constructed for example from plastic which provides a different R-factor (heat flux factor). The dry ice block 12 is disposed within a chamber 46 within the container 40. The chamber 46 is sized and shaped to receive the dry ice block 12 therein. To prevent the ice block 12 from being moved around in the chamber 46 and to avoid breakage of the ice block, the chamber 46 will have a height sufficient to accommodate the ice block when the top 42 is closed such that the ice block is sandwiched between the top 42 and bottom 44 to prevent the ice block from being disrupted in the chamber 46. The dry ice block 12 is effectively immobilized in the chamber 46.

In FIG. 3C, a non-insulated container 48 is shown in which the dry ice block 12 is disposed. In the non-insulated container 48, there is a chamber 50 therein to receive the dry ice block 12. The chamber 50 receives the dry ice block 12 so that same does not move around and become broken during transport. As with the container 40 of FIGS. 3A-3B, breakage of the dry ice block 12 would compromise the surface area:mass ratio and therefore, adversely impact the sublimation qualities of the dry ice block resulting in failure to adequately chill or freeze the products being transported. In the embodiment of FIG. 3C, a top 52 and a bottom 54, including other sidewalls of the container, can be manufactured from plastic material or cardboard to facilitate recycling and biodegradable qualities of the container. The embodiment of FIG. 3C may be best suited for transport of products, such as for example grocery products that must remain in a frozen state until receipt by the end-user.

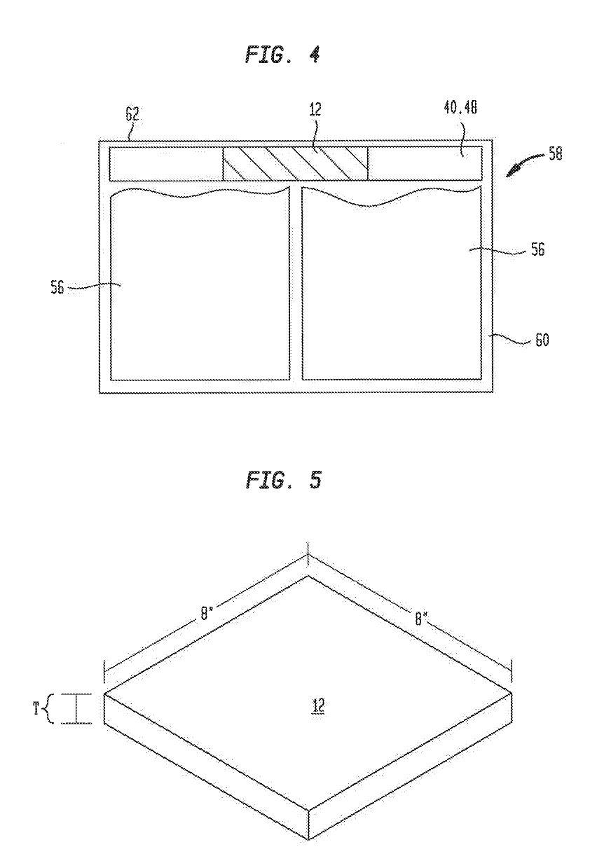

FIG. 4 shows food products 56 or a plurality of grocery bags disposed in a tote 58 to transport the food products to a remote location, such as for example to an end use customer. The tote 58 includes an interior space 60 in which the food products 56 are received, said interior space being sized and shaped to also receive either one of or both of the containers 40, 48 for chilling and/or freezing of the food products, depending upon the delivery operations. The container 40, 48 with the dry ice block 12 disposed therein is seated or nested on top of the food products 56, and a top 62 or cover of the tote 58 closed and sealed so that the tote can be transported to the end user.

Referring to FIG. 5, the dry ice block 12 is shown which corresponds for example to the low ratio ice block embodiment 12a having the cross-section shape 34 of FIG. 2A. The dimensions of the dry ice block 12a are by way of example only and such dimensions (8″L×8″ W) may of course be varied depending upon the product being chilled or frozen, and other conditions during the transport of the product to the end user. A thickness (T) will vary depending upon the surface area:mass ratio of the ice block 12a being used.

Referring to the Figures, it is possible to estimate dry ice usage versus ice block surface area. Accordingly, for given dimensions of a dry ice block, ie its surface area and weight, a relationship between a surface area to weight ratio versus refrigeration per unit mass can be obtained. For given dimensions of a dry ice block, ie its surface area and weight, a corresponding refrigeration per unit mass of the ice block 12 can be calculated. Refrigeration per unit mass is compared to the refrigeration requirements of the tote 58 so that a geometry and weight of the ice block can be selected and produced having the proper geometric dimensions and weight conducive to the products 52 being shipped.

The calculations, formulas, Example and table which follow illustrate a relationship between a surface area to weight ratio versus refrigeration per unit mass.
Variable Tair: −20° F. (Frozen) L Block Thickness=variable (ft.)
Tdryice: −109° F. A=block area=variable (ft.²)
   Results from Thermo/Heat Transfer Properties Table
   v=Kinematic viscosity (air)=8.76×10⁵ ft²/s
   k=Thermal conductivity (air)=0.01086 BTU/(hr.×ft×° F.)
   Pr=Prandtl number (air)=0.736
   b=Coefficient of thermal expansion (1/T) (air)=0.004796

$$Gr ( Grashof number ) = {\underline{( 9.81 \times b \times ABS ( T dryice - Tair ) ) \times {L}^{3}}}_{{v}^{2}}$$

$$Nu ( Nusselt number ) = {[ \begin{matrix}0.825 + \underline{0.387 \times ( {( Pr \times Gr )}^{0.166}} ) \\ {( 1 + {( 0.492 / Pr )}^{0.5625} )}^{0.296}\end{matrix} ]}^{2}$$

$$h ( Convective heat transfer ) = ( 4 \text{/} 3 ) \times ( {\underline{Nu \times k}}_{L} ) ( w \text{/} {m}^{2} \times ° C . )$$

$$g ( refrigeration ) = h \times A \times ( Tair - Tdryice ) ( w ) or ( Btu \text{/} hr )$$

### Example

Tair=−20° F. (−28.9° C.) Dry ice=100 lb/ft.³
Tdryice=−109° F. (−78.3° C.)
Dry ice block=FIG. 5

| A | | | | | F |
|---|---|---|---|---|---|
| Block | B | C | D | E | Surf |
| Thickness | Weight | Sur area | RFR | Refr/Mass | area:wt |
| (inches) | (lb) | (in²) | (BTU/hr) | (BTU/hr/lb) | (in²/lb) |
| 1 | 3.7 | 160 | 227 | 61.4 | 43.2 |
| 2 | 7.4 | 192 | 238 | 32.2 | 25.9 |
| 3 | 11.1 | 224 | 260 | 23.4 | 20.2 |
| 4 | 14.8 | 256 | 386 | 19.3 | 17.3 |
| 5 | 18.5 | 288 | 320 | 17.3 | 15.6 |

Column “D” provides the refrigeration of corresponding dry ice blocks having the characteristics set forth in columns “A”-“C”. Referring to columns “E” and “F”, the refrigeration per unit mass decreases with decreasing surface area:weight ratio.

The process above will allow for safe, controlled and long duration transport of chilled or frozen groceries with the use of specially formed dry ice blocks within a well-insulated tote.

The present embodiments provide for controlling refrigeration of the products, such as food products, being transported from a distribution site to a remote location for an end use customer. The embodiments also provide for a longer duration of acceptable chilling and/or refrigeration of the products and an efficient use of the dry ice being used during shipment of the products. Finally, end use customers are protected from contact with the dry ice used, chilled and/or maintained as frozen for the products being transported.

It will be understood that the embodiments described herein are merely exemplary, and that a person skilled in the art may make variations and modifications without departing from the spirit and scope of the invention. All such variations and modifications are intended to be included within the scope of the invention as defined herein and with respect to the appended claims. It should be understood that the embodiments described above are not only in the alternative, but can be combined.

What is claimed is:

1. A method for calculating a dry ice block necessary to preserve a product during transport, comprising:
calculating a surface area:weight ratio needed for the dry ice block to preserve the product in at least one of a chilled condition and a frozen condition; and
forming the dry ice block into a shape having said surface area:weight ratio.

2. The method of claim 1, further comprising positioning the dry ice block having the shape with the product for transport.

3. The method of claim 1, wherein the product is a consumable selected from the group consisting of a food product, and groceries.

4. The method of claim 1, wherein the calculating comprises:
$$Gr ( Grashof number ) = {\underline{( 9.81 \times b \times ABS ( T dryice - Tair ) ) \times {L}^{3}}}_{{v}^{2}} ;$$
$$Nu ( Nusselt number ) = {[ \begin{matrix}0.825 + \underline{0.387 \times ( {( Pr \times Gr )}^{0.166}} ) \\ {( 1 + {( 0.492 / Pr )}^{0.5625} )}^{0.296}\end{matrix} ]}^{2} ;$$
$$h ( Convective heat transfer ) = ( 4 \text{/} 3 ) \times ( {\underline{Nu \times k}}_{L} ) ( w \text{/} {m}^{2} \times ° C . ) ; and$$
$$g ( refrigeration ) = h \times A \times ( Tair - Tdryice ) ( w ) or ( Btu \text{/} hr ) ;$$
wherein,
v=Kinematic viscosity (air)=8.76×10⁵ ft²/s
k=Thermal conductivity (air)=0.01086 BTU/(hr.×ft×° F.)
Pr=Prandtl number (air)=0.736
b=Coefficient of thermal expansion (1/T) (air)=0.004796

5. The method of claim 1, wherein the dry ice block comprises carbon dioxide (CO₂) snow.

6. The method of claim 1, further comprising restraining movement of the dry ice block during the transport.

7. An apparatus for transporting a product in at least one of a chilled condition and a frozen condition, comprising:
a dry ice block with a surface area:weight ratio for providing at least one of said chilled and frozen conditions for the product;
a container having a chamber therein sized and shaped to receive the dry ice block; and
a tote having an internal space therein sized and shaped to receive the product and the container.

8. The apparatus of claim 7, wherein the container includes sidewalls constructed and arranged to immobolize the dry ice block in the chamber.

9. The apparatus of claim 8, wherein the container is an insulated container.

10. The apparatus of claim 9, wherein the insulated container comprises a top and a bottom between which the dry ice block is sandwiched.

11. The apparatus of claim 10, wherein the top comprises an aerogel portion, and the bottom is constructed of plastic.

12. The apparatus of claim 8, wherein the container is a non-insulated container.

13. The apparatus of claim 12, wherein the non-insulated container comprises a top and a bottom between which the dry ice block is sandwiched.

14. The apparatus of claim 13, wherein the top and the bottom are each constructed of a material selected from the group consisting of plastic material, and cardboard material.

15. An apparatus for extruding a dry ice block to be transported with a perishable product, comprising:
a cylinder having a chamber therein and in which a piston is disposed for reciprocal movement, and an outlet for the chamber;
a pipe in communication with the chamber for introducing CO₂ snow into the chamber;
a die having a select cross-section shape for the dry ice block, the die removably mountable to the outlet to be interchangeable with another die having another cross-section shape; and
a cutting member positioned downstream of the outlet for cutting an individual ice block from said outlet, said individual ice block having a surface area:weight ratio for providing at least one of a chilled condition and a frozen condition to the perishable product.

16. The apparatus of claim 15, wherein the cutting member comprises a blade.
